(19) United States
(12) Patent Application Publication
(10) Pub. No.: US 2011/0242415 A1
(43) Pub. Date: Oct. 6, 2011

(54) VIDEO-AUDIO PROCESSING APPARATUS AND VIDEO-AUDIO PROCESSING METHOD

(75) Inventor: Hidenori WAKABAYASHI, Oume-shi (JP)

(73) Assignee: KABUSHIKI KAISHA TOSHIBA, Tokyo (JP)

(21) Appl. No.: 13/028,601

(22) Filed: Feb. 16, 2011

(30) Foreign Application Priority Data
Mar. 31, 2010 (JP) 2010-083451

(51) Int. Cl. H04N 3/27

(52) U.S. Cl. 348/554; 348/E03.049

(57) ABSTRACT

According to one embodiment, a video-audio processing apparatus includes: an HDMI (High-Definition Multimedia Interface) terminal connectable with an HDMI-compatible device through an HDMI cable, the HDMI-compatible device having an HDMI-compatible input terminal, a non-HDMI-compatible input terminal and a switch configured to switch therebetween; and a controller configured to send a control command based on HDMI-CEC (Consumer Electronics Control) standard from the HDMI terminal to the HDMI-compatible device through the HDMI cable so as to change over the switch between the HDMI-compatible input terminal and the non-HDMI-compatible input terminal in the HDMI-compatible device.

### CROSS-REFERENCE TO RELATED APPLICATION(S)

This application is based upon and claims the benefit of priority from Japanese Patent Application No. 2010-083451, filed on Mar. 31, 2010, the entire contents of which are incorporated herein by reference.

### FIELD

Embodiments described herein relate generally to a video-audio processing apparatus having a digital interface for processing a signal such as a video-audio signal, and a video-audio processing method.

### BACKGROUND

In recent years, for a highly-functional television receiver (video-audio processing apparatus), a digital interface, such as a High-Definition Multimedia Interface (HDMI) input terminal, capable of transmitting/receiving a video-audio signal and a control signal through a single cable is provided. The High-Definition Multimedia Interface and the HDMI are trademarks.

An HDMI cable is provided with a CEC (Consumer Electronics Control) line for transmitting/receiving commands between devices. CEC includes not only commands (control signals) previously defined for all venders to be shared thereamong, but also commands opened for each vender so that each vender can realize unique extended functions.

JP-2009-124535-A discloses an example technique for controlling an HDMI-compatible device using a CEC line (Paragraphs 0027 to 0029, 0036 to 0037, 0045 to 0048, etc.). In the technique, control signals are exchanged through a CEC line between an external device (STB: Set Top Box) and a TV set when the STB is connected to the TV set through an HDMI cable so that the STB (external device) is included as one of selection items on an input switching menu and operated by a remote controller of the TV set.

In recent years, an HDMI terminal is also provided in an external device such as an AV selector or an AV amplifier, and a system may be built so that a TV set and a DVD player (source device) are connected through the AV amplifier.

Generally, an AV amplifier has an analog signal input terminal (e.g. a terminal for inputting an analog audio signal) in addition to the HDMI terminal. In such non-HDML terminal, a device not compatible with the HDMI standards is connected.

It is assumed that, an AV amplifier has an HDML terminal and a non-HDML terminal, and an HDML-compatible device and a non-HDML-compatible device are respectively connected thereto. CEC allows switching only among devices connected via HDML terminals. Therefore, in the above case, while it is possible to switch to the HDML-compatible device from the TV set, it is not possible to switch to the non-HDML-compatible device from the TV set. And, the user have to directly manipulate the AV amplifier to switch to the non-HDML-compatible device.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates a TV system according to an embodiment.

FIG. 2 illustrates an example of screen transition in response to an input switching operation in the TV system.

FIG. 3 illustrates an example of screen transition where an operation right is passed from a device operation menu of one HDMI device directly to another in the TV system.

### DETAILED DESCRIPTION

In general, according to one embodiment, there is provided a video-audio processing apparatus, including: an HDMI (High-Definition Multimedia Interface) terminal connectable with an HDMI-compatible device through an HDMI cable, the HDMI-compatible device having an HDMI-compatible input terminal, a non-HDMI-compatible input terminal and a switch configured to switch therebetween; and a controller configured to send a control command based on HDMI-CEC (Consumer Electronics Control) standard from the HDMI terminal to the HDMI-compatible device through the HDMI cable so as to change over the switch between the HDMI-compatible input terminal and the non-HDMI-compatible input terminal in the HDMI-compatible device.

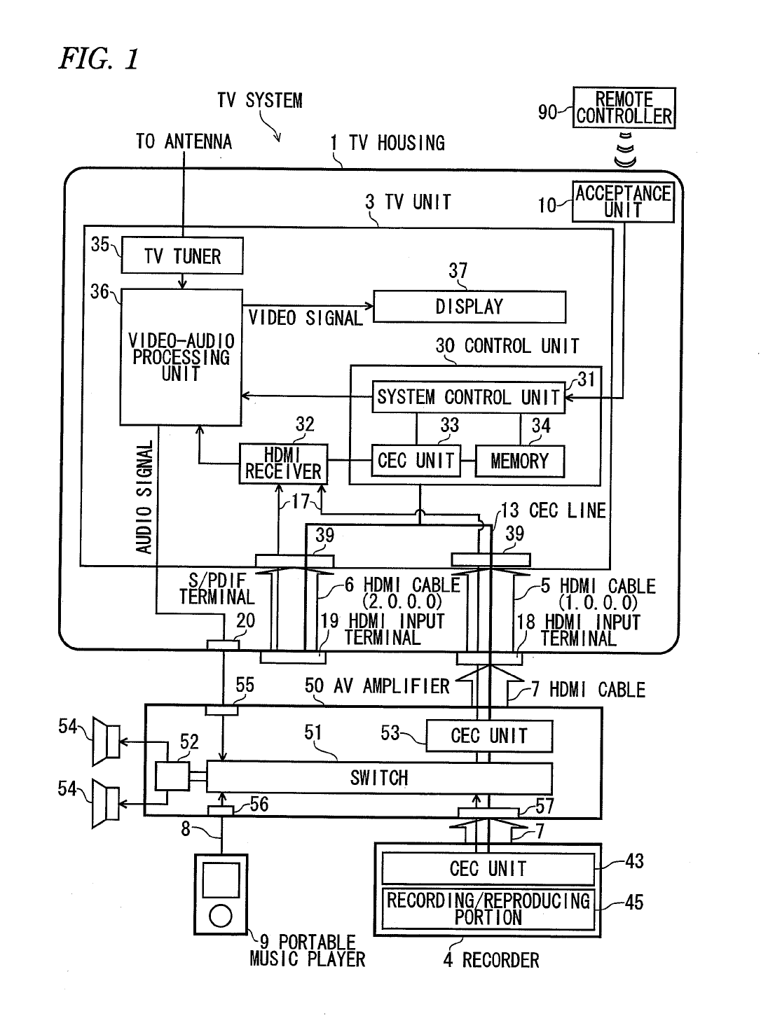

A television system (TV system) as an embodiment of a video-audio processing apparatus will be described below in detail with reference to the drawings. FIG. 1 illustrates the TV system.

As shown in FIG. 1, the TV system according to the embodiment has a display 37 for displaying video, an acceptance unit 10, an audio output terminal such as a Sony Philips Digital Interface terminal (S/PDIF terminal) 20, a TV housing 1 which houses functional parts for generating information to be outputted to the display 37 and the S/PDIF terminal 20, and HDMI input terminals 18 and 19 provided in the TV housing 1 to establish external connections. The acceptance unit 10 accepts a control signal from a remote controller (RC) 90 or an operation portion provided on the TV housing 1 (apparatus body). The control signal serves to perform an input switching operation among devices (such as an AV amplifier 50 and a recorder 4).

HDMI-compatible devices to be connected to the HDMI input terminals 18 and 19 through HDMI cables 5, 6 and 7 are referred to as HDMI devices. In this example, the AV amplifier 50, the recorder 4 connected to the AV amplifier 50 through the HDMI cable 7, etc. are HDMI devices.

The number of HDMI input terminals 18 and 19 or 57 provided in the TV housing 1 or the AV amplifier 50 is not limited to one or two but may be (more than) three. S/PDIF is an interface standard between devices for inputting/outputting audio digital signals.

Inside the TV housing 1, the HDMI cable 5 for internal wiring is connected from the HDMI input terminal 18 to a TV unit 3, and the HDMI cable 6 for internal wiring is connected from the HDMI input terminal 19 to the TV unit 3. Each HDMI cable 5, 6 includes a hot plug detection line (HPD line), a +5 V power supply line, etc. as well as a CEC line 13 and a video-audio data line 17. The HPD line is a line through which an HPD signal is sent from a control unit 30 to each HDMI device. The +5 V power supply line is a line through which a voltage of +5 V is applied to the control unit 30 from an HDMI device powered on.

The CEC line 13 is branched and connected to the AV amplifier 50 and the control unit 30. Commands (various control commands) are exchanged between the AV amplifier 50 and the control unit 30 through the CEC line 13 so that devices connected through the HDMI cables 5, 6 and 7 can be detected, and operation control, signal switching control, etc. can be performed on the devices.

Examples of the commands transmitted and received through the CEC line 13 include vender commands, deck control commands, play forward commands, active source commands, etc. The vender commands are used for controlling individual functions unique to respective venders. The vender commands, the deck control commands and the play forward commands are direct commands whose destinations are specified. As an example of the vender commands unique to the respective venders, in the embodiment, a command for the RC 90 to perform a signal switching operation on the AV amplifier 50 may be provided.

The TV unit 3 includes the control unit 30, an HDMI receiver 32 to which the HDMI cables 5, 6 for internal wiring are connected, a TV tuner 35 connected to an antenna, a video-audio processing unit 36, the display 37, etc.

The HDMI receiver 32 detects connection of an external device to the HDMI input terminals 18, 19 (HDMI cables 5, 6), and changes an HPD signal from de-asserted (suspended state) to asserted (active state) in order to transmit the HPD signal to the external device. When the AV amplifier 50 is connected to the HDMI input terminal 18 (HDMI cable 5) as in FIG. 1, the HDMI receiver 32 transmits the HPD signal to the AV amplifier 50, or the recorder 4 connected thereto. The HPD signal is sent to the AV amplifier 50 through the HPD line of the HDMI cables 5 and 7.

The TV tuner 35 receives a television broadcast inputted through the antenna, and outputs video and audio of a program of the received television broadcast to the video-audio processing unit 36. The TV tuner 35 has at least one of a digital tuner and an analog tuner. In addition, plural digital tuners and/or plural analog tuners may be mounted in the TV tuber 35.

The video-audio processing unit 36 reproduces digital video-audio data or an analog video-audio signal supplied from the TV tuner 35, and digital video-audio data supplied from the HDMI receiver 32.

Under the control of the control unit 30, the video-audio processing unit 36 changes over data or signals inputted from the TV tuner 35 and the HDMI receiver 32, to the display 37 and the S/PDIF terminal 20. In addition, the video-audio processing unit 36 displays a CEC ON/OFF setting selection screen on the display 37.

When the user operates a not-shown operation button provided in the RC 90 or on the TV housing 1 to select ON (use) or OFF (no use) on the CEC ON/OFF setting selection screen displayed on the display 37, a system control unit 31 of the control unit 30 sets the CEC ON/OFF setting (ON (use) or OFF (no use)) into a memory 34. When a multi-screen display function is provided, the video-audio processing unit 36 performs a reproducing process to display different input sources (video sources) on plural split screens.

The display 37 displays video reproduced by the video-audio processing unit 36 on the screen. The S/PDIF terminal 20 is a terminal through which an audio signal reproduced by the video-audio processing unit 36 is outputted to the outside. The S/PDIF terminal 20 is connected to a terminal 55 of the AV amplifier 50 through a coaxial cable or an optical fiber cable.

The control unit 30 includes the system control unit 31, a CEC unit 33 and the memory 34.

The contents of the CEC ON/OFF setting (ON (use) or OFF (no use)), that is, CEC ON/OFF setting data are stored in the memory 34. That is, setting data indicating use or no use of the device control function (CEC function) for controlling each HDMI device through the CEC line 13 are stored in the memory 34.

Logical addresses “0” to “15” HDMI devices can acquire respectively, physical addresses “1.0.0.0” and “2.0.0.0” of respective HDMIs, physical addresses of the HMDI devices, etc. are also stored in the memory 34. In this example, physical addresses of the AV amplifier 50 and the recorder 4 are stored.

The physical address assigned to each HDMI device is not unique to the device, but is decided and assigned to each device by the CEC unit 33 of the control unit 30 in accordance with the connection position (connection port) of the device. For example, when a port of the HDMI receiver 32 to which the HDMI cable 5 is connected has the physical address of HDMI1 (1.0.0.0), HDMI1-1 (1.1.0.0) is assigned to the AV amplifier 50 which is externally connected to the port, and HDMI1-2 (1.2.0.0) is assigned to the recorder 4 which is connected to the AV amplifier 50 as an HDMI device.

The system control unit 31 controls the inside of the TV unit 3 in accordance with an RC operation command accepted by the acceptance unit 10, and delivers the RC operation command (a command for signal switching operation on the AV amplifier 50, a command for switching to each menu with a hierarchal structure, a command for CEC ON/OFF setting selection operation, or the like) to the CEC unit 33. That is, in accordance with a control signal accepted by the acceptance unit 10, the system control unit 31 transmits a control command for switching an input terminal of a device on which an input switching operation has been performed on a device operation menu screen. The control command is to cyclically switch the input terminal of the device.

The system control unit 31 sends a control command compatible with the HDMI-CEC standard from the HDMI input terminal 18 (HDMI terminal), to the AV amplifier 50 (HDMI device), through the HDMI cable 7. Here, the AV amplifier 50 has the input terminal 57 compatible with HDMI, input terminals 55 and 56 not compatible with HDMI, and a switch 51 to switch therebetween. Thus, the system control unit 31 serves as a control unit to control switching of the switch 51 for switching between the HDMI input terminal 57 and the input terminals 55 and 56 provided in the AV amplifier 50.

The system control unit 31 also serves as a display control unit for displaying a device operation menu for an externally connected device (such as the AV amplifier 50 or the recorder 4) on the display 37. The device operation menu is provided for switching an input terminal through which an input signal from another device should be inputted.

The CEC unit 33 controls each unit through the CEC line 13 (shared control line) from the HDMI cable 5, in accordance with a received command.

When the received command is, for example, a command of video reproducing operation on the recorder 4, the system control unit 31 controls the video-audio processing unit 36 to reproduce video-audio data supplied from the recorder 4 and output a video signal to the display 37 and an audio signal to the S/PDIF terminal 20.

When the received command is a command of signal switching operation on the AV amplifier 50, the CEC unit 33 transmits that command to the AV amplifier 50 through the CEC line 13 so as to change over the switch 51 of the AV amplifier 50.

On this occasion, the CEC unit 33 confirms the setting data in the memory 34. When the CEC ON/OFF setting is set as “ON”, that is, use to use the device control function under CEC, the CEC unit 33 transmits the command. When the CEC ON/OFF setting is set as “OFF”, that is, no use not to use the device control function under CEC, the CEC unit 33 does not transmit the command. In this example, assume that the CEC ON/OFF setting is set as “ON”, that is, use to use the device control function under CEC.

For example, the AV amplifier 50 etc. as an externally connected device is removably connected to the HDMI input terminal 18 through the multi-purpose HDMI cable 7. The AV amplifier 50 is provided with the S/PDIF terminal 55, the analog input terminal 56, the HDMI input terminal 57, etc.

An S/PDIF cable from the S/PDIF terminal 20 of the TV housing 1 is connected to the S/PDIF terminal 55. An analog audio signal cable 8 connected to an analog audio output terminal of a non-HDMI-compatible device (such as a portable music player 9) is connected to the analog input terminal 56. The recorder 4 which is an HDMI-compatible device is connected to the HDMI input terminal 57 through the HDMI cable 7.

When the HPD signal is changed to be active, the CEC unit 43 performs a polling operation through the HDMI cable 5. In the polling operation, there is issued a request to acquire an address including a physical address of an HDMI device (recorder 4) assigned in accordance with each port and a candidate for a logical address for communication read from the memory 34.

After that, when an acknowledgement (ACK) indicating the candidate for the logical address is in use is not received from any other HDMI device (such as the AV amplifier 50), the CEC unit 43 decides that candidate as a logical address for communication, and transmits an address decision notification with communication addresses including the decided logical address and the physical address of the recorder 4 to the CEC unit 33 of the control unit 30 through the CEC line 13.

The AV amplifier 50 as an externally connected HDMI device is connected to the HDMI input terminal 18. The AV amplifier 50 includes the switch 51, an amplifier portion 52, a CEC unit 53, the S/PDIF input terminal 55, the analog audio signal input terminal 56, the HDMI input terminal 57, etc. The AV amplifier 50 serves as a switching device for switching an input terminal of a source (audio signal) to be outputted to speakers 54 from the TV housing 1 under the CEC.

The switch 51 switches an input terminal of an externally inputted audio signal among the input terminals 55, 56 and 57 under the control of the CEC unit 53. The switch 51 is, for example, a rotary signal changeover switch.

The amplifier portion 52 converts inputted digital audio data from one of the input terminals 55, 56 and 57 into an analog audio signal and amplifies the analog audio signal, or amplifies an inputted analog signal so that the amplifier portion 52 outputs the amplified analog audio signal to the left and right speakers 54.

As soon as the HPD signal is changed to be active when the AV amplifier 50 is connected to the TV housing 1, the CEC unit 53 performs a polling operation through the HDMI cables 5 and 7. In the polling operation, there is issued a request to acquire an address including a physical address assigned to the AV amplifier 50 (device's own physical address) and a candidate for a predetermined logical address. When an acknowledgement (ACK) indicating the candidate logical address is in use is not received from any other HDMI device (such as the recorder 4), the CEC unit 53 decides the candidate as a logical address for communication, and transmits an address decision notification with communication addresses including the decided logical address and the physical address of the AV amplifier 50 to the CEC unit 33 of the control unit 30 through the CEC line 13.

The CEC unit 53 controls the switch 51 to switch an input terminal of an externally inputted audio signal among the input terminals 55, 56 and 57 based on the control command received through the CEC line 13.

For example, assume that the input terminal through which a signal should be inputted has been switched to the input terminal 57, and an audio signal from the recorder 4 is being outputted from the speakers 54. On this occasion, when the user uses the RC 90 to display a device operation menu screen (AV amplifier) on the display 37 and performs, for example, an operation of “switch input”, an instruction of “switch input” is issued from the system control unit 31 to the CEC unit 33. The CEC unit 33 sends a control command to switch the terminal in accordance with the instruction, to the AV amplifier 50 through the CEC line 13.

In the AV amplifier 50, the CEC unit 53 switches the signal input terminal to the terminal 56 when the command to switch the terminal is received from the TV housing 1 through the CEC line 13. Thus, an analog audio signal inputted from the portable music player 9 can be outputted to the speakers 54.

The recorder 4 as an externally connected HDMI device is connected to the HDMI input terminal 57 of the AV amplifier 50. The recorder 4 includes the CEC unit 43, a recording/reproducing portion 45, etc. The CEC unit 43 exchanges commands with the CEC unit 33 of the control unit 30 through the CEC line 13 in the same manner as the AV amplifier 50, so as to perform operations such as switching the operation right to the TV side. The recording/reproducing portion 45 has a TV tuner etc. for receiving a TV broadcast, recording and reproducing a TV program and outputting reproduced video and audio signals to the AV amplifier 50.

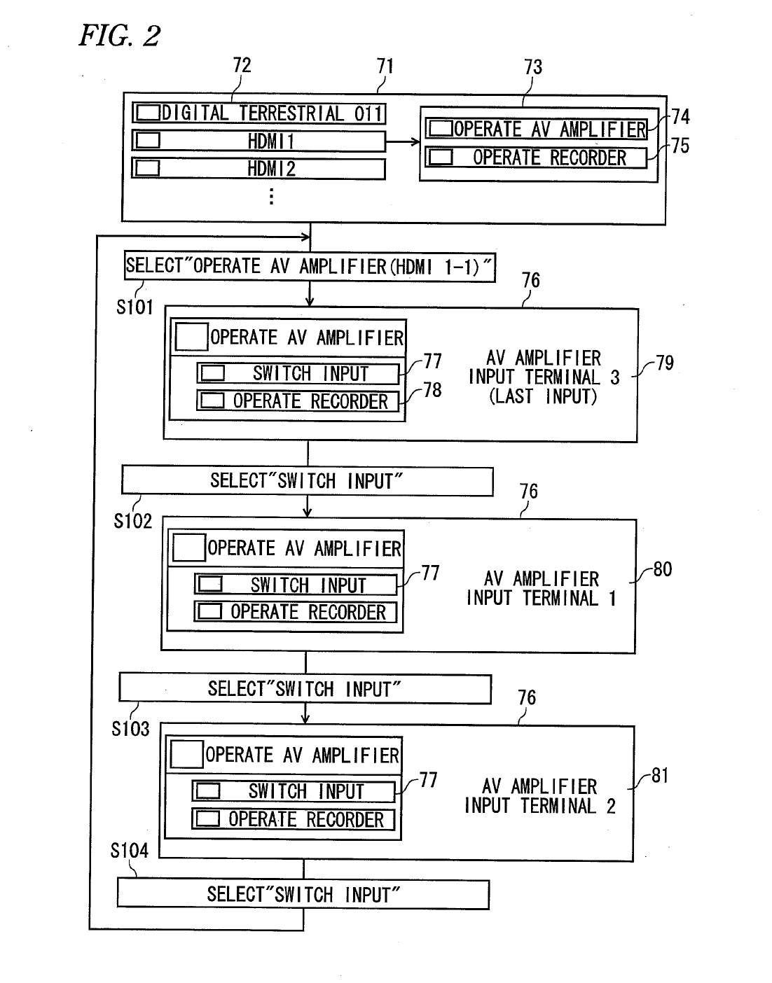

The operation of the TV system according to this embodiment will be described below. First, the input terminal switching operation on the AV amplifier 50 will be described with reference to FIG. 2.

(Input Switching Operation) FIG. 2 illustrates an example of the input switching operation (input terminal switching operation on the AV amplifier) to be performed by RC operation on a menu screen displayed on the display 37.

In this TV system, an AC plug extracted from the TV housing 1 is inserted into a commercial power source such as a socket in a home wall. When primary power is supplied to a power supply unit (not shown) in the TV housing, operating power is supplied from the power supply unit to the TV unit 3.

When the operating power is supplied from the power supply unit to the TV unit 3, the HDMI receiver 32 in the TV unit 3 exchanges signals with the AV amplifier 50 through the CEC line 13 to detect connections with the AV amplifier 50 and the recorder 4. The HDMI receiver 32 notifies the system control unit 31 of the detection of the connections. The system control unit 31 makes corresponding device names active to allow the user to select a device on a device selection menu screen. The system control unit 31 performs the following screen control operation.

Here, when the user operates the RC 90 to display an input switching screen 71 on the display 37 as shown in FIG. 2, items such as “digital terrestrial 011”, “HDMI 1”, “HDMI 2”, . . . are displayed as a list 72 of currently switchable items on the input switching screen 71.

When the user operates the RC 90 to select the “HDMI 1” in the item list 72 (Step S101), a second-layer device selection menu 73 are displayed to present an “operate AV amplifier” item 74 and an “operate recorder” item 75. That is, items for switching the operation right of input switching between HDMI-compatible devices are provided in the device operation menu 73 (screen).

Further, when the user operates the RC 90 to select the “operate AV amplifier” item 74 in the device selection menu 73 (Step S101), an AV amplifier device operation menu 76 as a device operation menu for each device is displayed.

For example, an “switch input” item 77 indicating the control of switching an input terminal and an “operate recorder” item 78 indicating the control of switching to another HDMI device are displayed as items of controllable functions of the AV amplifier 50 in the device operation menu 76. Next to these items, a name (item) 79 of an input terminal such as “AV amplifier input terminal 3”, which is the last inputted terminal, is displayed.

Here, assume that the S/PDIF input terminal 55 of the AV amplifier 50 corresponds to the “AV amplifier input terminal 1” item on the screen, the analog signal input terminal 56 corresponds to the “AV amplifier input terminal 2” item on the screen, and the HDMI input terminal 57 corresponds to the “AV amplifier input terminal 3” item on the screen.

The setting of the HDMI input terminal 57 as the last inputted terminal has been held in the memory 34. In this setting, video and audio signals from the recorder 4 connected to the HDMI input terminal 57 are inputted into the AV amplifier 50 and outputted from the speakers 54.

Here, when the user operates the RC 90 to select the “switch input” item 77 in the device operation menu 76 (Step S102), the items (the “switch input” item 77 and the “operate recorder” item 78) of the device operation menu 76 are left as they are, while a name (item) 80 such as “AV amplifier input terminal 1”, which indicates the next input terminal to be switched to on the AV amplifier 50 side is displayed next to the items of the device operation menu 76.

In the setting of “AV amplifier input terminal 1”, the terminal through which a signal should be inputted in the AV amplifier 50 is switched to the S/PDIF input terminal 55. Thus, TV audio is outputted from the speakers 54.

Successively, when the user operates the RC 90 to select the “switch input” item 77 in the device operation menu (Step S103), the items (the “switch input” item 77 and the “operate recorder” item 78) of the device operation menu 76 are left as they are, while a name (item) 81 such as “AV amplifier input terminal 2”, which indicates the next input terminal to be switched to is displayed next to the items of the device operation menu 76.

In the setting of “AV amplifier input terminal 2”, the terminal through which a signal should be inputted in the AV amplifier 50 is switched to the analog signal input terminal 56. Thus, audio (music) of the portable music player 9 which is a non-HDMI-compatible device is outputted from the speakers 54.

Further, when the user operates the RC 90 to select the “switch input” item 77 in the device operation menu 76 (Step S104), the items (the “switch input” item 77 and the “operate recorder” item 78) of the device operation menu 76 are left as they are, while the name (item) 79 such as “AV amplifier input terminal 3”, which indicates the next input terminal to be switched to is displayed next to the items of the device operation menu 76.

The terminal through which a signal should be inputted in the AV amplifier 50 is switched again to the initial input terminal 57. Video and audio signals from the recorder 4 are inputted to the AV amplifier 50 and audio reproduced by the recorder 4 is outputted from the speakers 54. After that, the item indicating the input terminal will be switched cyclically every time when the “switch input” item 77 is operated.

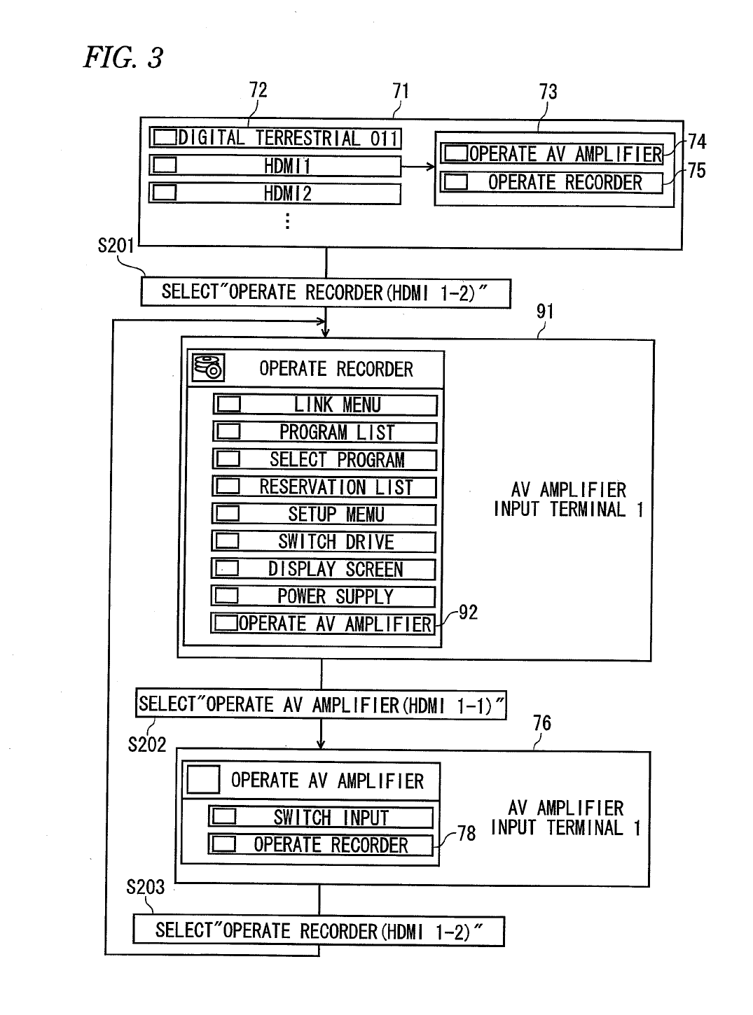

Next, from the device operation menu of each HDMI device externally connected to the TV housing 1, the operation to move (switch) the operation right directly to another HDMI device will be described with reference to the screen transition diagram of FIG. 3.

When the user operates the RC 90 to display the input switching screen 71 on the display 37 as shown in FIG. 3, items such as “digital terrestrial 011”, “HDMI 1”, “HDMI 2”, . . . are displayed as a list 72 of currently switchable items on the input switching screen 71.

When the user operates the RC 90 to select the “HDMI 1” in the item list 72 (Step S101), the second-layer device selection menu 73 in which the “operate AV amplifier” item 74 and the “operate recorder” item 75 are displayed is displayed.

Further, when the user operates the RC 90 to select the “operate recorder” item 75 in the device selection menu 73 (Step S201), a recorder device operation menu 91 as a device operation menu for each device is displayed.

Items of controllable functions of the recorder 4, such as a “link menu” item, a “program list” item, a “select program” item, a “reservation list” item, a “setup menu” item, a “switch drive” item, a “display screen” item, a “power supply” item, an “operate AV amplifier” item 92, etc. are displayed in the device operation menu 91.

Successively, when the user operates the RC 90 to select the “operate AV amplifier” item 92 in the device operation menu 91 (Step S202), the screen is switched by the system control unit 31, so that the device operation menu 76 for controlling the functions of the AV amplifier 50 as shown in FIG. 2 is displayed.

Further, when the user operates the RC 90 to select the “operate recorder” item 78 in the device operation menu 76 (Step S203), the screen is switched by the system control unit 31, so that the device operation menu 91 for controlling the functions of the recorder 4 is displayed again.

As described above, according to the TV system in this embodiment, a control command based on the CEC standard of HDMI is sent from the HDMI input terminal 18 provided in an HDMI-compatible device (TV housing 1) to the AV amplifier 50 through the HDMI cables 5 and 7, so as to make control to change over the switch 51 for switching the input terminal of the AV amplifier 50 among the HDMI input terminal 57 and the non-HDMI-compatible input terminals 55 and 56 provided in the AV amplifier 50. Thus, an audio signal to be inputted from the portable music player 9 to the AV amplifier 50 which is a device connected to the TV housing 1 through the HDMI cable 7 can be switched under the control of the TV housing 1 side (the RC 90).

That is, HDMI-compatible devices (the TV housing 1 and the AV amplifier 50) are connected to each other, and the signal changeover switch 51 provided in one of the HDMI-compatible devices (the AV amplifier 50) is controlled so that a signal can be switched between an input from a non-HDMI-compatible device (the portable music player 9) to the HDMI-compatible device (the AV amplifier 50) and an input from the HDMI-compatible device (recorder 4). Thus, it is possible to obtain the same effect as if the HDMI-compatible device (the recorder 4) and the non-HDMI-compatible device (the portable music player 9) were controlled on the TV side.

The invention is not limited to the aforementioned embodiment. For example, constituent members may be modified without departing from the scope of the invention. Each constituent member in the aforementioned embodiment may be implemented with a program installed in a storage such as a hard disk unit of a computer. In addition, the program may be stored in computer-readable electronic media so that the functions of the embodiments can be implemented by the computer which reads the program from the electronic media, such as CD-ROMs, flash memories, removable media, etc. Further, constituent members may be distributed and stored in different computers connected through a network, so that functions of the embodiments can be implemented through communication among the computers serving as the constituent members.

What is claimed is:

1. A video-audio processing apparatus, comprising:
a terminal comprising a receptacle connector compliant with a first standard, configured to connect to a device compliant with the first standard through a cable comprising at least one plug connector compliant with the first standard, the device comprising
a first input terminal compliant with the first standard,
a second input terminal not compliant with the first standard and
a switch configured to switch between the first input terminal and the second input terminal; and
a controller configured to send a control command based on the first standard from the terminal to the device through the cable in order to switch between the first input terminal and the second input terminal in the device, wherein the first standard is related to a digital audio and video interface for transmitting uncompressed digital data.

2. The apparatus of claim 1, further comprising:
a display; and
a display controller configured to control the display to display a device operation menu screen comprising an item which allows to switch between the input terminals of the device according to an input signal from a second device.

3. The apparatus of claim 2, further comprising:
a reception module configured to receive a control signal for an input switching from a remote controller or an operation button on the device to the device,
wherein the display controller is configured to transmit a control command in order to switch an input terminal of the device on the device operation menu screen, in accordance with the received control signal.

4. The apparatus of claim 3,
wherein the display controller is configured to transmit a control command in order to cyclically switch the input terminal of the device.

5. The apparatus of claim 2,
wherein the device operation menu screen further comprises an item to switch between a controlling device and a controlled device for an input switching between devices compliant with the first standard.

6. The apparatus of claim 1,
wherein the second input terminal is an analog audio signal input terminal.

7. A video-audio processing method for a video-audio processing apparatus comprising a terminal compliant with a first standard configured to connect to a device compliant with the first standard through a cable compliant with the first standard, the device comprising a first input terminal compliant with the first standard, a second input terminal not compliant with the first standard and a switch configured to switch between the first input terminal and the second input terminal, the method comprising:
sending a control command based on the first standard from the terminal to the device through the cable in order to switch between the first input terminal and the second terminal in the device, wherein the first standard is related to a digital audio and video interface for transmitting uncompressed digital data.

8. The video-audio processing apparatus of claim 1, wherein the first standard is the High-Definition Multimedia Interface (HDMI).

9. The video-audio processing method for the video-audio processing apparatus of claim 7, wherein the first standard is the High-Definition Multimedia Interface (HDMI).

10. A video-audio processing apparatus, comprising:
a first input terminal comprising a first receptacle connector compliant with the first standard and configured to connect to a first device compliant with the first standard through a cable comprising at least one plug connector compliant with the first standard;
a second input terminal comprising a second receptacle connector not compliant with the first standard and configured to connect a second device not compliant with the first standard through a cable comprising at least one plug connector not compliant with the first standard; and
a switch configured to switch between the first input terminal and the second input terminal,
wherein the first input terminal is configured to receive a control command based on the first standard from a terminal of the first device through the cable, and to switch between the first input terminal and the second input terminal in response to the control command, and
wherein the first standard is related to a digital audio and video interface for transmitting uncompressed digital data.

11. The video-audio processing apparatus of claim 10, wherein the first standard is the High-Definition Multimedia Interface (HDMI).
